(19) United States
(12) Patent Application Publication
(10) Pub. No.: US 2022/0100455 A1
(43) Pub. Date: Mar. 31, 2022

(54) DUAL DISPLAY SYSTEMS AND METHODS

(71) Applicant: Tobii AB, Danderyd (SE)

(72) Inventors: Sourabh PATERIYA, Danderyd (SE); Deepak Akkil, Danderyd (SE); Onur Kurt, Danderyd (SE); Erland George-Svahn, Danderyd (SE)

(73) Assignee: Tobii AB, Danderyd (SE)

(21) Appl. No.: 17/421,700

(22) PCT Filed: Jul. 1, 2020
(86) PCT No.: PCT/EP2020/050178

§ 371 Date: Jul. 8, 2021

Related U.S. Application Data
(60) Provisional application No. 62/789,870, filed on Jan. 8, 2019.

(51) Int. Cl. G06F 3/14; G06F 3/01; G06F 3/041

(52) U.S. Cl. CPC G06F 3/1423; G06F 3/0416; G06F 3/013

(57) ABSTRACT

The present invention generally relates to systems and methods for interaction with devices containing dual displays, and in particular, to systems and methods for enabling or altering the functionality of a secondary display based on a user's attention.

### FIELD OF INVENTION

The present invention generally relates to systems and methods for interaction with devices containing dual displays, and in particular, to systems and methods for enabling or altering the functionality of a secondary display based on a user's attention.

### BACKGROUND OF THE INVENTION

Laptops, phones, personal computers and the like typically comprise a display for communicating information to a user. Recently systems have been proposed containing more than one display. For example, the Macbook Pro product by Apple Inc incorporates a secondary light emitting diode known as the “Touchbar”.

In systems utilizing a secondary display, particularly those powered by batteries or the like, power consumption is a known problem. In essence, it is desirable to only power the secondary display when it is in use, to avoid power wastage.

It is further an issue for the system to know when the user desires to use the secondary display.

Eye tracking technology is a known technology whereby a user's eye or eyes are tracked to determine the user's gaze direction. Typically, this technology utilizes an image sensor to capture images of an illuminated eye of a user, with the illumination be affected by an infrared illuminator. Based on an analysis of these captured images, a gaze direction of a user may be deduced.

It is also possible to determine gaze, or attention, using an image sensor without infrared illumination. For example, by analysis of facial features, orientation, pupil position and the like. A person of skill in the art would readily identify multiple ways to determine the gaze direction or attention of a user, and the method for determining such is not the subject of the present application.

It is an objective of the present invention to solve at least one of the previously identified problems.

### SUMMARY OF THE INVENTION

Embodiments for interaction with a device containing dual displays, and in particular, to computing devices and methods for enabling or altering the functionality of a secondary display based on a user's attention, are disclosed.

More specifically, a computing device comprising a first display, a second display and an attention determination unit for determining a user's attention toward the first display, or second display, is disclosed.

### BRIEF DESCRIPTION OF THE DRAWINGS

A further understanding of the nature and advantages of various embodiments may be realized by reference to the following FIGURE:

FIG. 1 discloses an overview of a computing device, according to an embodiment.

The FIGURE is schematic, not necessarily to scale, and only show parts which are necessary in order to elucidate the respective embodiments, whereas other parts may be omitted or merely suggested.

### DETAILED DESCRIPTION

Thus, an object of the present invention is to provide systems and methods for utilizing a user's attention to direct the functionality of a secondary display. This and other objects of the present invention will be made apparent from the specification and claims together with appended drawings.

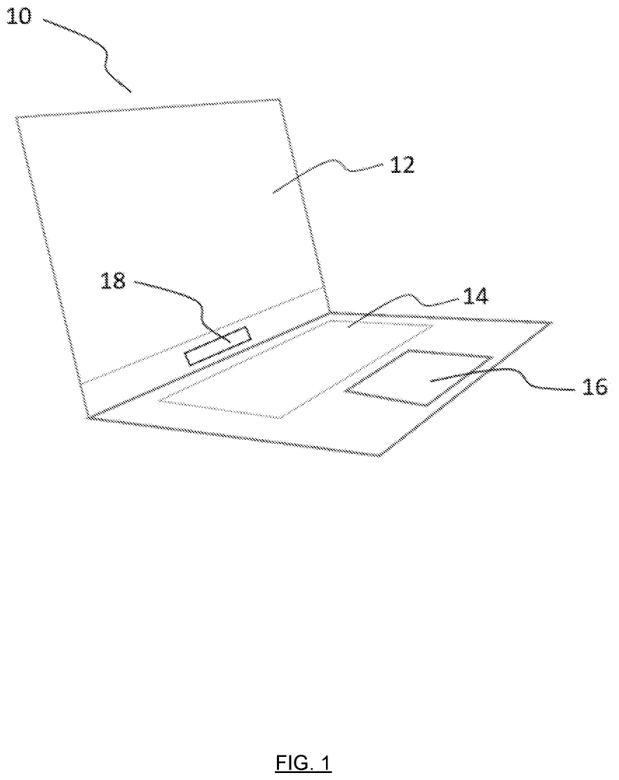

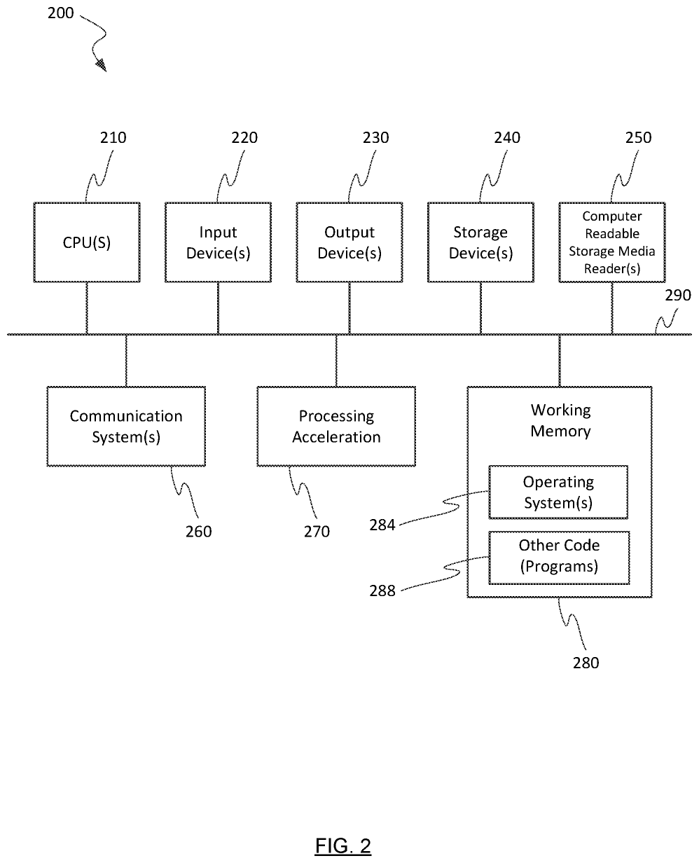

FIG. 1 discloses an overview of a computing device 10, according to an embodiment. The computing device 10 may comprise a primary display 12, a keyboard 14, a secondary display 16, an attention tracking device 18 and computing components (not shown). The computing components typically comprise at least a processor, memory, storage and graphics processor. The computer components receive information and generate information to be displayed by the primary display 12 and/or the secondary display 14, as would be readily understood by a person of skill in the art.

The primary display 12 may be referred to as a first display. The secondary display 16 may be referred to as a second display. However, according to another example, the primary display 12 may be referred to as a second display and the secondary display 16 may be referred to as a first display.

The attention tracking device 18 may be in the form of an eye tracking device comprising an image sensor and infrared illuminator, or in any other form known and able to determine a user's attention towards the primary display 12, secondary display 16 or elsewhere. This may include for example an image sensor without any specialized light sources.

Further, the attention tracking device 18 may be able to determine if the user is looking at the keyboard 14. Yet further, the attention tracking device 18 may be able to determine if the user is looking at a distinct area of the primary display 12 or the secondary display 16, for example displaying a window or a program, such as a voice assistant, a music player or a chat client. Also, the attention tracking device 18 may be able to determine if the user is looking at a further area, outside the primary display 12 and secondary display 16. The further area may be positioned at the computing device 10. Yet further, the further area may be visualized to the user in the form of an icon, an illuminator or a set of illuminators.

The secondary display 16 may be combined with contact sensitive components, such as a touch screen, pressure-sensitive screen or the like, such that the secondary display 16 may function not only as a display, but as a touch sensitive input, such as a touchpad or the like.

Information gathered by the attention tracking device 18, such as images captured by the attention tracking device 18, are interpreted by a set of computing components to determine whether a user of the computing device 10 is paying attention to the primary display 12, or secondary display 16. Paying attention may be as simple as the user gazing toward the primary display 12, or secondary display 16, potentially including the user gazing toward the keyboard 14 and/or the further area, or it may further involve more complicated determinations such as the context in which the user is interacting with the computing device 10.

This determination of attention may be used in multiple ways by the computing device.

In a first use of the attention determination, the computing device 10 may operate such that when the user is paying attention to the primary display 12, the secondary display 16 is lowered in brightness, contrast, or some other display property which provides the effect of making it easier for a user to view the primary display 12. This could include for example altering higher a property of the primary display 12, such as brightness. Alternatively, this method may operate in vice-versa, whereby the primary display 12 decreases in brightness, contrast, or the like when the user is paying attention to the secondary display 16.

In a second use of the attention determination, the computing device 10 may operate such that when it is determined that a user is paying attention to the primary display 12, the secondary display 16 may function as a conventional touchpad, as can be found on most laptops and portable computers. In this mode, the secondary display 16 need not display any information, and merely function as a touchpad input device for the computing device 10. Although if the secondary display 16 does display information, it will still operate in the same mode as a traditional touchpad. If it is determined that the user is paying attention to the secondary display 16, the secondary display 16 may function as a touch screen whereby a user may contact items displayed on the display in a manner similar to that found in conventional touch screens, such as those found on mobile phones and the like.

In a third use of the attention determination, the computing device 10 may operate such that the volume of audio emitted by the computing device 10, and associated with the primary display 12, is adjusted when the user is paying attention to the secondary display 16 or elsewhere. Alternatively, the volume of audio emitted by the computing device 10, and associated with the secondary display 16, is adjusted when the user is paying attention to the primary display 12 or elsewhere.

In a fourth use of the attention determination, the computing device 10 may operate such that an item information may be displayed on the primary display 12, and upon attention of the user turning to the secondary display 16, enhanced information regarding the item of information is displayed on the secondary display 16.

By way of example of this fourth use, the computing device 10 may display a notification on the primary display 12, such as a notification that a new email has been received. Upon determination by the computing device 10 that the user is paying attention to the secondary display 16, within a period of time from the display of the notification, enhanced information is displayed on the secondary display 16. In this example, that enhanced information may be further contents of the email. When the computing device 10 determines the user is no longer paying attention to the secondary display 16, the enhanced information may be removed from the secondary display 16.

In a fifth use of the attention determination, the computing device 10 may operate such that there is information displayed on both the primary display 12, and the secondary display 16. Upon a determination that the user's attention switches from the primary display 12, to the secondary display 16, any input devices associated with the computing device 10 provide input which affects information on the secondary display 16. Upon return of the user's attention to the primary display 12, any input devices associated with the computing device 10 provide input which affects information on the primary display 12. Such input devices may comprise the keyboard 14, a mouse and/or a microphone.

In one example, the input device(s) associated with the computing device 10, do(es) not directly switch to provide input which affects information on the primary display 12 upon return of the user's attention to the primary display 12. Instead the input device(s) may continue to provide input which affects information on the secondary display 16 for a predetermined time, as long as the user uses the input device, by for example receiving keystroke input from the keyboard 14 within a predetermined time period since the last keystroke input or receiving sound/voice input from the microphone within a predetermined time period since the last sound/voice input, or until an additional event occur. The same reasoning could be applied when the user's attention switches from the primary display 12 to the secondary display 16.

The attention determination described and referred to herein may further incorporate, or indeed solely rely on any of, different data sets. Although the present invention has been described with reference to an image based solution, such as an eye tracking device, other types of data which may be used include, but are not limited to:
contextual data such as history of use of the computing device 10,
the profile or identity of a user using the computing device 10,
audio based input such as speech,
other input device information,
head, facial features, or other body features of a user of the computing device 10,

Further, additional inputs may be used to enact an attention determination. For example, a physical input device such as a keyboard, mouse, touchpad or the like, in combination with an attention determination may trigger any of the proposed uses of the attention determination.

FIG. 2 is a block diagram illustrating a specialized computer system 200 in which embodiments of the present invention may be implemented. This example illustrates specialized computer system 200 such as may be used, in whole, in part, or with various modifications, to provide the functions of the devices discussed above, or to implement the methods disclosed.

Specialized computer system 200 is shown comprising hardware elements that may be electrically coupled via a bus 290. The hardware elements may include one or more central processing units 210, one or more input devices 220 (e.g., a mouse, a keyboard, etc.), and one or more output devices 230 (e.g., a display device, a printer, etc.). Specialized computer system 200 may also include one or more storage device 240. By way of example, storage device(s) 240 may be disk drives, optical storage devices, solid-state storage device such as a random access memory (“RAM”) and/or a read-only memory (“ROM”), which can be programmable, flash-updateable and/or the like.

Specialized computer system 200 may additionally include a computer-readable storage media reader 250, a communications system 260 (e.g., a modem, a network card (wireless or wired), an infra-red communication device, Bluetooth™ device, cellular communication device, etc.), and working memory 280, which may include RAM and ROM devices as described above. In some embodiments, specialized computer system 200 may also include a processing acceleration unit 270, which can include a digital signal processor, a special-purpose processor and/or the like.

Computer-readable storage media reader 250 can further be connected to a computer-readable storage medium, together (and, optionally, in combination with storage device(s) 240) comprehensively representing remote, local, fixed, and/or removable storage devices plus storage media for temporarily and/or more permanently containing computer-readable information. Communications system 260 may permit data to be exchanged with a network, system, computer and/or other component described above.

Specialized computer system 200 may also comprise software elements, shown as being currently located within a working memory 280, including an operating system 284 and/or other code 288. It should be appreciated that alternate embodiments of specialized computer system 200 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of specialized computer system 200 may include code 288 for implementing any or all of the function of the various elements of the architecture as described herein. For example, software, stored on and/or executed by a specialized computer system such as specialized computer system 200, can provide the functions of components of the invention such as those discussed above, or to otherwise implement the methods discussed herein. Methods implementable by software on some of these components have been discussed above in more detail.

The invention has now been described in detail for the purposes of clarity and understanding. However, it will be appreciated that certain changes and modifications may be practiced within the scope of the disclosure.

1. A computing device comprising:
a first display,
a second display,
an attention determination unit for determining a user's attention toward the first display, or second display.

2. The computing device of claim 1, where the attention determination unit comprises an eye tracking device.

3. The computing device of claim 1, where the attention determination unit comprises an image sensor.

4. The computing device of claim 3, where the attention determination unit contains a processing unit for analyzing images captured by the image sensor.

5. The computing device of claim 1, where the second display is touch sensitive.

6. The computing device of claim 5, where upon the attention determination unit determining the user's attention is toward the first display, operating the second display as a touch sensitive input device for the computing device.

7. The computing device of claim 5, where upon the attention determination unit determining the user's attention is toward the second display, operating the second display as a touch sensitive screen input device, where information displayed on the second display can be interacted with through touch.

8. The computing device of claim 5, where upon the computing device displaying a notification on the first display and upon the attention determination unit determining the user's attention is toward the second display, displaying enhanced information regarding the notification on the second display.

9. The computing device of claim 5, where upon the attention determination unit determining the user's attention is toward the second display, providing, by an input device associated with the computing device, input which affects information on the second display.

10. Any of the apparatuses and/or methods disclosed herein.
